(19) United States
(12) Patent Application Publication
(10) Pub. No.: US 2006/0224575 A1
(43) Pub. Date: Oct. 5, 2006

(54) System and method for dynamic creation and management of lists on a distance user interface

(75) Inventor: Bojana Ostojic, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/095,764

(22) Filed: Mar. 30, 2005

(51) Int. Cl. G06F 17/30

(52) U.S. Cl. 707/4

(57) ABSTRACT

An exemplary method includes displaying a graphical user interface that comprises a menu of types of media, receiving a command issued from a remote control specifying a type of media, in response to the command, displaying a graphical user interface for selecting items of the media, receiving one or more commands issued from the remote control to select items to thereby make a list of the items, identifying an application associated with the type of media and providing information for the application wherein the information comprises one or more properties about each item of the list. Various other exemplary methods, devices, systems, etc., are also disclosed

### RELATED APPLICATIONS

This application is related to U.S. Patent Application entitled, “Enabling UI template customization and reuse through parameterization”, to Glein, Hogle, Stall, Mandryk and Finocchio, filed on Mar. 30, 2005, having Attorney Docket No. MS1-2488US (which is incorporated by reference herein); U.S. patent application entitled “Context menu navigational method for accessing contextual and product-wide choices via remote control”, to Ostojic, Glein and Sands, filed on Mar. 30, 2005, having Attorney Docket No. MS1-2490US (which is incorporated by reference herein); and U.S. patent application entitled “System for efficient remote projection of rich interactive user interfaces”, to Hogle, filed on Mar. 30, 2005, having Attorney Docket No. MS1-2491US (which is incorporated by reference herein).

### TECHNICAL FIELD

Subject matter disclosed herein relates generally to techniques for creating or managing lists.

### BACKGROUND

Recent technological innovations are turning the home computer into a multimedia center. For example, the WINDOWS® XP® MEDIA CENTER EDITION 2005™ operating system (Microsoft Corporation, Redmond, Wash.) is an operating system that enables users to enjoy entertainment, personal productivity, and creativity on a personal computer in an easy, complete, and connected way. This operating system includes features that allow a user to store, share, and enjoy photos, music, video, and recorded TV via a personal computer. In essence, such features create a so-called media center personal computer (PC). Media center PCs represent the evolution of PCs into digital media hubs that bring together entertainment choices. A media center PC with the WINDOWS® XP® MEDIA CENTER EDITION 2005™ operating system can even be accessed or controlled using a single remote control.

With respect to use of a remote control for input, the user experience differs in many ways when compared to the user experience associated with input via a keyboard and a mouse. Thus, a user interface and associated input methods may not provide the user with a good experience when implemented in a “10′ context”, i.e., where input is via a remote control. Indeed, use of a UI and associated methods developed for a 2′ context, when used in a 10′ context, may deter use.

In general, a user's visual experience in the 10′ context is in many ways more critical than in the 2′ context. The 2′ context is more akin to reading a book (i.e., “normal” text and image presentation) and being able to point at the text or images with your finger while the 10′ context is more akin to watching TV, where a remote control is aimed at a device, where viewing habits for users are quite varied and where viewers are more accustomed to viewing images, single words or short phrases, as opposed to lines of text. Without a doubt, the advent of the 10′ context has raised new issues in the development of user interfaces.

As described herein, various exemplary methods, devices, systems, etc., aim to facilitate list making. In various instances, such exemplary technology can facilitate list making or management of lists via user interfaces in the 10′ context.

### SUMMARY

The techniques and mechanisms described herein are directed at making, using or editing lists or items. An exemplary computer-implementable method includes displaying a graphical user interface that comprises a menu of types of media, receiving a command issued from a remote control specifying a type of media, in response to the command, displaying a graphical user interface for selecting items of the type of media, receiving one or more commands issued from the remote control to select items to thereby make a list of the items, identifying an application associated with the type of media and providing information for the application wherein the information comprises one or more properties about each item of the list. Various other exemplary methods, devices, systems, etc., are also disclosed.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram of an exemplary context that includes a display to display a user interface and a remote control for input and interaction with the user interface.

FIG. 2 is a diagram of exemplary remote control for use in the system of FIG. 1.

FIG. 3 is a diagram of two exemplary user interfaces suitable for use in the system of FIG. 1.

FIG. 4 is a diagram of an exemplary method for navigating one or more user interfaces or between user interfaces for list making and related actions.

FIG. 5 is a diagram of an exemplary system that includes a host computer and exemplary interfaces or applications that pertain to listing making and related activities.

FIG. 6 is a diagram of an exemplary application that includes methods and properties related to list making or management of lists.

FIG. 7 is a diagram of three exemplary user interfaces suitable for use in the system of FIG. 1 and that may rely on the exemplary application of FIG. 6.

FIG. 8 is a diagram illustrating an exemplary computing environment, which may be used to implement various exemplary methods, etc., described herein.

### DETAILED DESCRIPTION

In the description that follows, various exemplary methods, devices, systems, etc., are presented. These examples rely on various exemplary application or interfaces that include exemplary methods, properties, etc. to facilitate user list creation or list management. As described in the Background Section, issues exist in the 10′ context when compared to the 2′ context and, exemplary technology presented herein is particularly useful for user interfaces for the 10′ context; however, such exemplary technology may be used for other contexts. In particular, such exemplary technology may be used where a user needs to create a list or where an application may utilize a list.

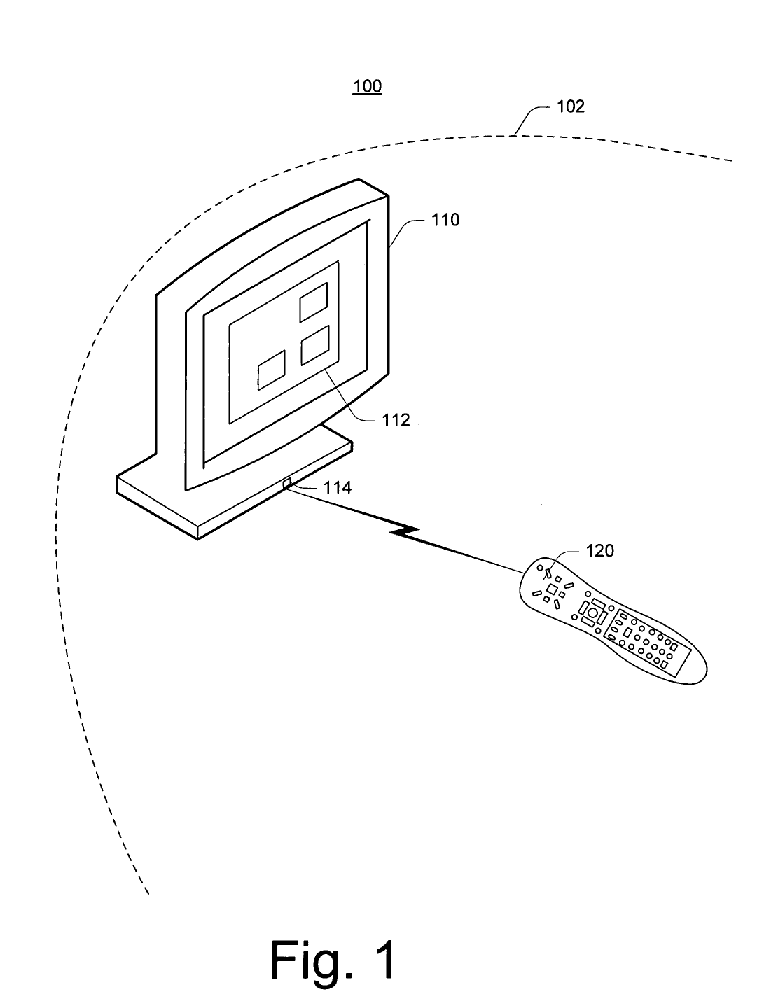

FIG. 1 shows an exemplary context 100 that has a context boundary 102 (e.g., 10′ or other distance). The context boundary 102 is typically defined by a distance or distances between a user and a user interface (UI). The exemplary context 100 is akin to a distance typically found in viewing TV. In the exemplary context 100, a display 110 displays a UI 112 and a remote control 120 communicates with a controller for the display via a communication port 114 (e.g., a remote sensor), which is typically a wireless communication port (e.g., infrared, etc.). The port 114 may be unidirectional from the remote control 120 to the port 114 or bidirectional between the port 114 and the remote control 120. The port 114 could be a peripheral device, or could also be built into either a computer or a monitor (as shown). The controller or host for the display 110 may be a computer located proximate to the display 110 or located remote from the display 110. Various communication techniques exist to allow a computer to provide display information to create a UI.

A user interface that works well at a distance of about ten feet should account for the fact that a typical remote control (e.g., the remote control 120) is smaller and easier to use than a conventional keyboard and mouse; however, it generally provides a more limited form of user input (e.g., due to fewer keys or buttons). And while a greater viewing distance provides a more comfortable experience, it can necessitate features that provide a visual design style to ensure clarity, coherence, and readability.

In both the 2′ context and the 10′ context, the user's expectations, mobility, habits, etc., should be considered when constructing a user interface (e.g., the UI 112). With respect to expectations, the 10′ experience is more like watching television than using a computer. As a result, users expect a dynamic, animated experience. They expect that the input device will make their experience simpler, not more complicated. They may also expect applications to be more convenient, simpler to learn, and easier to use than applications controlled by the keyboard or mouse.

As described herein, various exemplary methods, devices, systems, etc., provide for list making via a user interface. More specifically, various examples use one or more list making applications that include various exemplary methods, properties, etc. The exemplary list making applications may be used to make lists for various types of media and various types of content. The exemplary list making applications generally interact with a list utilizing application that may control hardware locally or remotely. For example, a list of music files may be created using an exemplary list making application where the list making application interacts with a list utilizing application that can direct a disk burner to burn a list of music files to a CD or DVD.

General User Interface Guidelines

In the 10′ context, the display may be a TV display, a computer monitor display or a projection screen display. With the advent of HDTVs, LCDs, plasma monitors, interoperability (TV or computer monitor) is often available in a single display.

General guidelines include text and graphics that are sufficiently large for display using lower clarity and resolution associated with a conventional TV display; caution when relying on fixed widths; size and position graphics relative to the screen resolution; avoid use of fine details that may blur on a conventional TV display; where limitations of interlaced scanning are present, size all lines, borders, and text to at least two pixels wide; and be aware that bright colors tend to over-saturate on a conventional TV display.

With respect to text, it is recommended to size all text, especially for critical content such as buttons and links, to at least 20 points. In addition, it is recommended to use lists of short phrases rather than paragraphs; move larger blocks of text onto secondary pages; edit text to remove any nonessential information; to use adequate contrast between text and its background, and to use light and dark values to create contrast.

With respect to a look and feel for UI buttons, an exemplary scheme may use a basic look for buttons associated a particular application (e.g., a basic look for links, option buttons, check boxes, sorting controls, controls to set the view, etc.). Where more than one application requires UI display, each application may have its own look. Such a scheme provides a user with a consistent experience and can help enable the user to quickly identify which items on the page are functional or used for navigation.

It is recommended that buttons be clearly visible against their surroundings and that the functions that they perform be inherent or obvious. For example, a label on a button may describe its function. For example, users can be expected to understand the function of “Save Settings” or “Play DVD” more easily than “OK” or “Go”.

It is recommended that when a user focuses on a button, the button be highlighted in a visually distinct manner, making it more visible than buttons that do not have the focus. A highlighting effect can be achieved by changing the background color of the button, or by placing a brightly colored border around the button.

For consistency and ease of use, a single consistent style of highlighting is recommended for each application (e.g., a highlight color that complements the colors of a particular design). Highlighting is part of a dynamic user experience; users generally notice highlights not just because of their contrast with other elements, but because of the movement of the highlight as they navigate around the page.

In the 10′ context, navigation should refer to not only movement between pages or screens, but also movement between selectable elements within a page. With respect to a remote control, users generally navigate by using the arrow buttons on the remote control to move the input focus to a particular item and then press “enter” to act on the focused item. For most UIs, it is typically recommended that the focus is always on one of the items in the UI.

In the 10′ context, it is recommended that page layouts be simple and clean, with a coherent visual hierarchy. A consistent design, from page to page, may include aligning UI items to a grid. It is further recommended that readability take precedence over decoration and that the inclusion of too many extraneous visual elements be avoided.

Example of a Remote Control

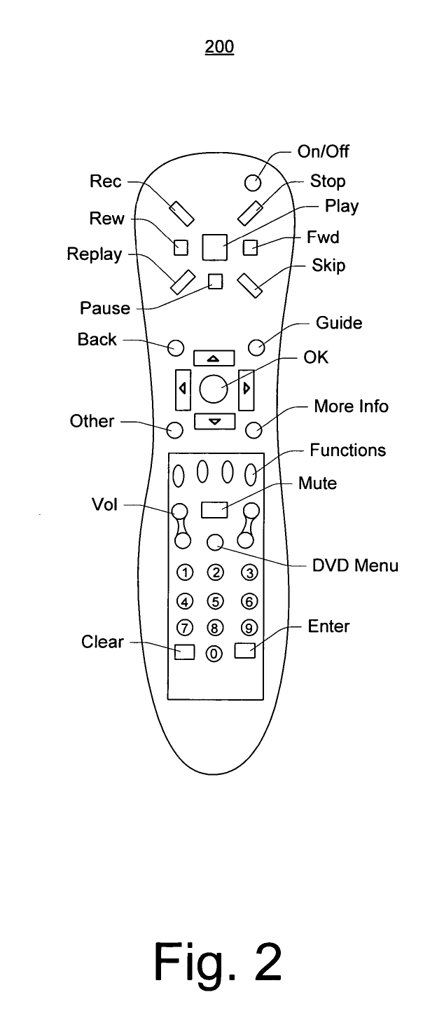

The appearance of a remote control may vary from manufacturer to manufacturer; however, core functionality is typically constant. FIG. 2 shows an exemplary remote control 200 and various buttons and associated functions some of which are described below.

As already mentioned, the remote control interacts with a sensor. A typical sensor may include the following hardware: a receiver component that processes input from the remote control; a circuit for learning commands (e.g., infrared communication commands); a universal serial bus (USB) connection that sends input notifications to software running on a host computer; and two emitter ports. In addition, the sensor normally requires a device driver that may support the Plug and Play specification. A USB cable or other cable may enable users to place a sensor near a monitor so they can point the remote substantially at the monitor when sending commands to the host computer. Alternatively, the sensor might be mounted in the front panel of the computer by the manufacturer, mounted in or on a monitor, etc.

Input from a remote control is typically processed as follows: the sensor receives the signal and forwards it to a device driver on the host computer; the device driver converts the input into a message (e.g., WM_INPUT, WM_APPCOMMAND, WM_KEYDOWN, WM_KEYPRESS, or WM_KEYUP message); the host computer software places these messages in A message queue to be processed; and the foreground application processes messages of interest. For example, a digital media streaming application could process the messages corresponding to the transport buttons (Pause, Play, Stop, Fast Forward, and Rewind) but optionally ignore messages from the numeric keypad.

While remote control design may vary by manufacturer, most remote controls have a set of standard buttons that fall into four categories: navigation buttons (e.g., eHome, Up, Down, Left, Right, OK, Back, Details, Guide, TV/Jump), transport buttons (e.g., Play, Pause, Stop, Record, Fast Forward, Rewind, Skip, Replay, AV), power-control buttons (e.g., Volume +, Volume −, Chan/Page +, Chan/Page −, Mute, DVD Menu, Standby) and data entry buttons (e.g., 0, 1, 2 ABC, 3 DEF, 4 GHI, 5 JKL, 6 MNO, 7 PQRS, 8 TUV, 9 WXYZ, Clear, Enter).

In addition to required buttons, a manufacturer may incorporate optional buttons. Optional buttons may include shortcut buttons (e.g., My TV, My Music, Recorded TV, My Pictures, My Videos), DVD buttons (e.g., DVD Angle, DVD Audio, DVD Subtitle), keypad buttons (e.g., #, *), and OEM-specific buttons (e.g., OEM 1, OEM 2). Various applications may not rely on the presence of these “optional” buttons.

Example of User Interfaces

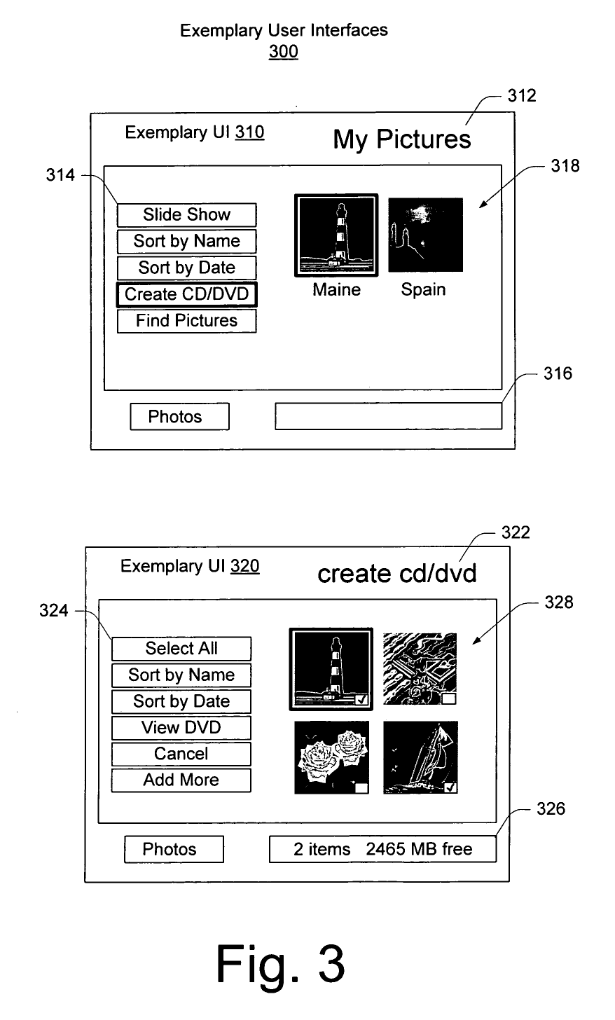

As already mentioned, a user interface may have features associated with or suitable for use in a certain context (e.g., 2′ context, 10′ context, etc.). FIG. 3 shows two exemplary user interfaces 310, 320 for list making that are optionally suitable for use in a 10′ context. The user interface 310 includes a title 312 “My Pictures”, a menu 314, an information area 316 and a presentation area 318 for pictures (e.g., photos, graphics, artwork, drawings, etc.). A user may access such a user interface via a media selection user interface, a special function button on a remote control, etc. The user interface 310 indicates by highlighting that a user has selected to create a CD or DVD and that a picture or pictures associated with “Maine” are to be copied to the CD or DVD. Thus, the user interface 310 may be associated with a first step in making a list.

A user interface 320 may be a subsequent user interface that appears upon a user selecting or highlighted a menu item and a picture or group of pictures in the user interface 310. The user interface 320 includes a title “create cd/dvd”, a menu 324 of operations, an information area 326 that displays the number of picture items selected (e.g., “2 items”) and an amount of free space (e.g., “2465 MB free”). The presentation area 328 shows four pictures where one picture is highlighted with a checked checkbox, another has a checked checkbox and the other two have unchecked checkboxes. Thus, two items are selected, for example, as items of a list for being copied to the CD or DVD.

Example of List Making

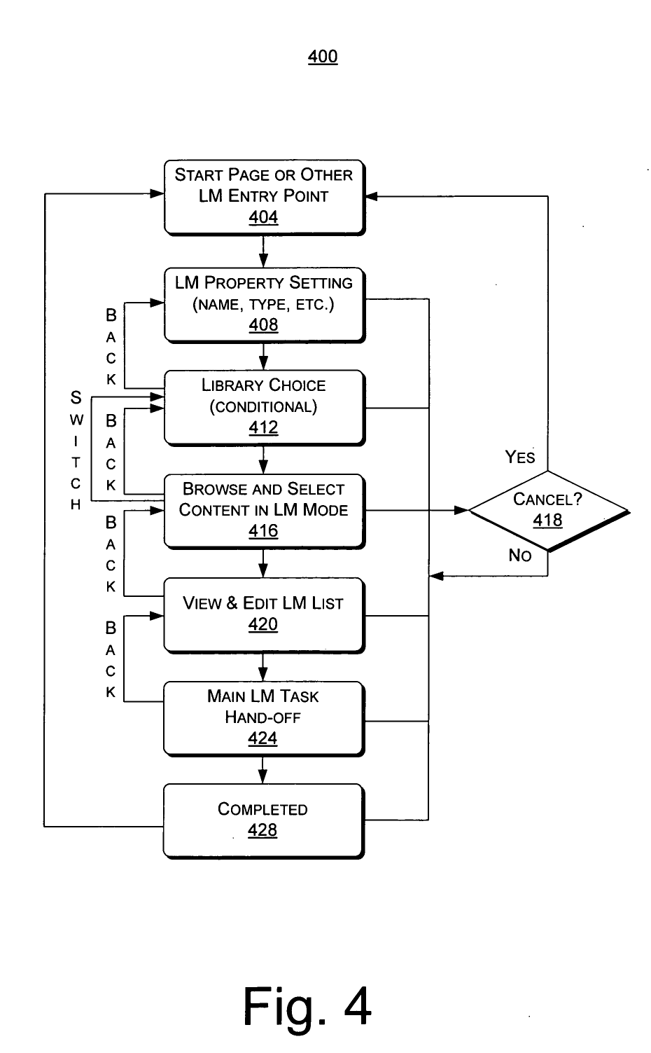

Navigation of one or more user interfaces or between user interfaces for list making may rely on control logic, e.g., an exemplary application for list making. FIG. 4 shows an exemplary method 400 that such an application may use for controlling navigation of a user interface(s).

The exemplary method 400 commences at a start block 404 where a user may enter a list making application. The entry point may be via a start page or other entry point (e.g., user interfaces that allow entry to list making). From the start block 404, the user may enter a property setting block 408 that allows the user to set list making properties such as name, type of media, etc. A library selection block 412 allows the user to select a library, which may occur in conjunction with property settings. For example, referring to the exemplary user interface 310 of FIG. 3, the properties may cause display of the user interface 310 where the libraries “Maine” and “Spain” are displayed for browsing or selection, which may occur via a browse and select block 416. The browse and select block 416 allows the user to browse and select content. A user interface may also allow for return to the library block 412 or other blocks. In the example of FIG. 4, the user may switch libraries or return to the library block 412 upon entering a “Back” command via a controller such as the remote control 200 of FIG. 2. A cancellation block 418, offers the user an opportunity to cancel the browsing or selection of content and may return to the start page or other page.

Importantly, the browse and select block 416 allows for list making, when a list making mode is enabled. Subsequent action blocks (e.g., 420, 424) in the exemplary method 400 operate to manage a list via operations such as viewing and editing (e.g., the view and edit LM list block 420) and handing-off the list to a list utilizing application or other application, device, interface, etc. (e.g., the main LM task hand-off block 424). A completion block 428 returns the exemplary method 400 to the start block 404 or other appropriate block (which may be other than the blocks shown).

An exemplary application provides list making capabilities operable in conjunction with a user interface and user input. The exemplary application is optionally an add-in to the aforementioned MEDIA CENTER EDITION™ operating system. An operating system may exchange file and other information with the exemplary application.

An exemplary computer-implementable method, or application that includes various methods, includes displaying a graphical user interface that comprises a menu of types of media, receiving a command issued from a remote control specifying a type of media, in response to the command, displaying a graphical user interface for selecting items of the type of media, receiving one or more commands issued from the remote control to select items to thereby make a list of the items, identifying an application associated with the type of media and providing information for the application wherein the information comprises one or more properties about each item of the list.

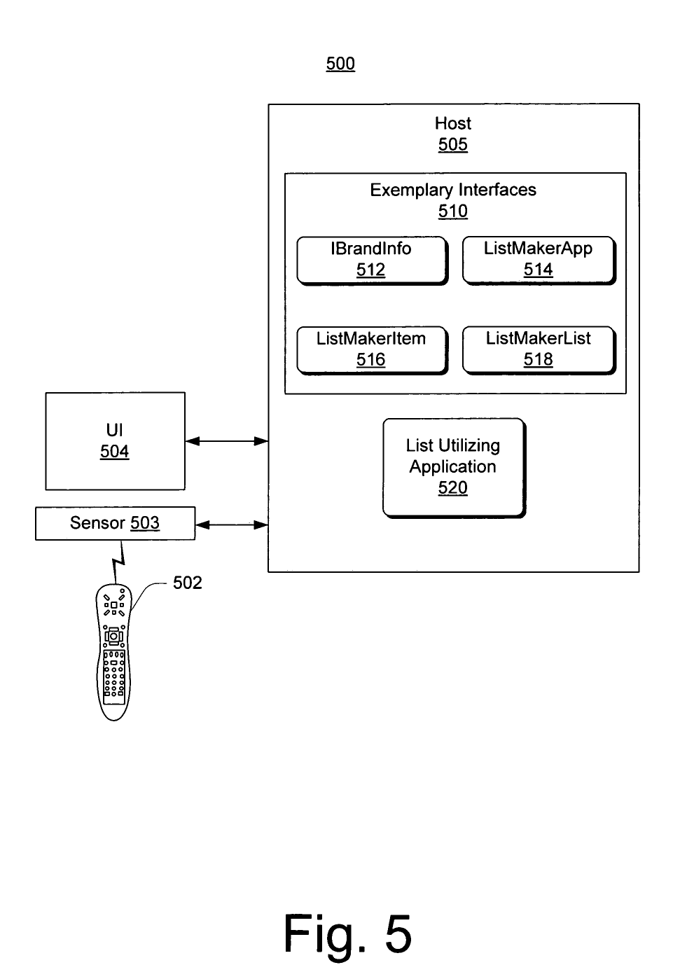

FIG. 5 shows an exemplary system 500 that includes a remote control 502, a sensor 503, a user interface 504 and a host 505. The host 505 hosts various exemplary interfaces 510 and a list utilizing application 520 that may rely on hardware, a network connection, etc. A user may view content on the user interface 504 and use the remote control 502 to transmit input to a sensor 503, which, in turn, transmits information to the host 505. The host 505 may be a computer such as a personal computer and may use an operating system such as the WINDOWS® MEDIA CENTER EDITION™ operating system.

The exemplary set of interfaces 510 are for list making and related tasks. The exemplary interfaces 510 are optionally features of an operating system of the host 505. The exemplary interfaces 510 allow a user, for example, using the remote control 502, to create lists, which, in turn, may be used by the list utilizing application 520. While the list utilizing application 520 is shown as being executed on the host 505, it may optionally execute on a device in communication with the host 505.

The interfaces 510 include a “brand information” interface 512 (IBrandInfo), a list maker application or interface 514 (ListMakerApp), a list maker item interface 516 (ListMakerItem), and a list maker list interface 518 (ListMakerList). The IBrandInfo interface 512 enables a list utilizing application to customize a list-making portion of a user interface, the ListMakerApp application or interface 514 enables a list utilizing application to receive user-created lists of files, the ListMakerItem interface 516 enables a list utilizing application to access individual items from a list of files created by a user, and the ListMakerList interface 518 enables a list utilizing application to access a collection of list items per a user created list.

The IBrandInfo interface 512 can provide strings or icons to customize a list-making part of a user interface whereby a list utilizing application may, for example, establish a brand identity. The ListMakerApp application 514 generally provides list items to a list utilizing application and may retrieve information from the list utilizing application, for example, about a recording or storage medium or associated capabilities of hardware or software (e.g., consider a portable music player that can display certain, but limited, information about a music file). Specific information may include total capacity of the medium and the amount of unused space remaining on the medium. The ListMakerApp application 514 can cause such information to be displayed on a user interface during making of a list.

The various exemplary interfaces may be computer-executable modules on one or more computer-readable media. For example, a collection of modules may include an information interface (e.g., IBrandInfo 512) that provides information related to a list utilizing application, a list maker interface (e.g., ListMakerApp 514) that provides for making of a list of items, a list maker list (e.g., ListMakerList 518) interface that provides a list utilizing application access to a collection of list items and a list maker item interface (e.g., ListMakerItem 516) that provides the list utilizing application access to individual items of a list. The list maker list interface may expose properties related to the list, the list maker item interface may expose properties for each item of the list and the information interface may expose properties of the list utilizing application.

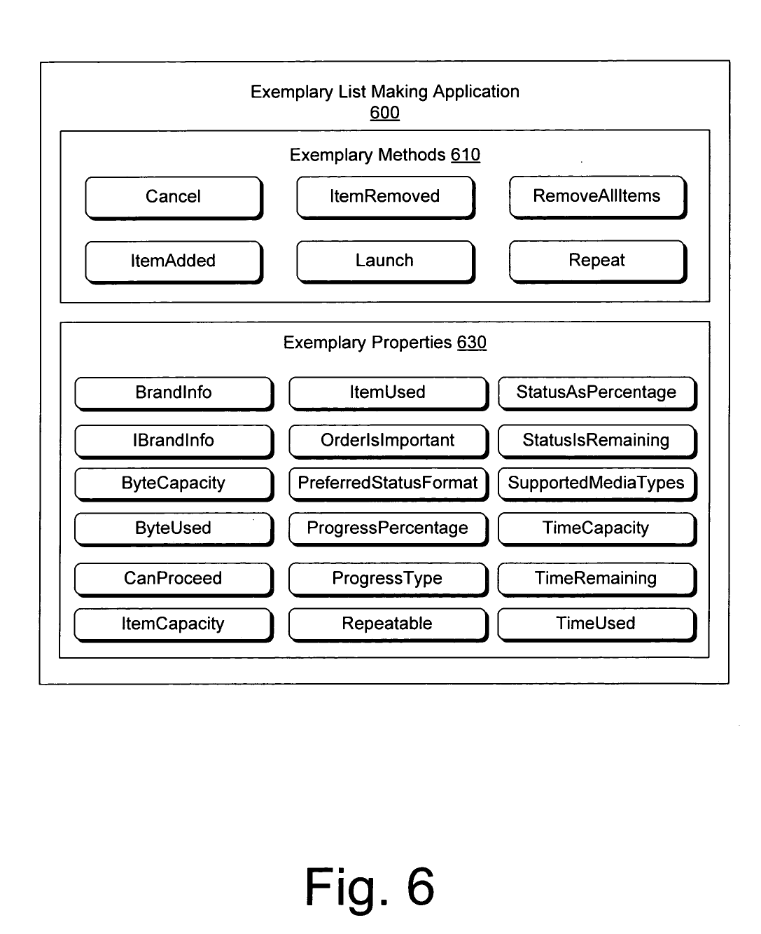

FIG. 6 shows an exemplary application 600 that provides list making capabilities, for example, consider the ListMakerApp application 514 of FIG. 5. The exemplary application 600 exposes various methods 610 and properties 630. The exemplary methods 610 include a cancel method (Cancel), an item added method (ItemAdded), an item removed method (ItemRemoved), a launch method (Launch), a remove all items method (RemoveAllItems) and a repeat method (Repeat).

Operation of these methods is explained with respect to list making or management during creation of a CD or DVD. For example, the exemplary application may be an interface (e.g., the ListMakerApp interface 514) that can gather lists of files from the user and provide them to a CD/DVD recording application. For communicating the actual list, a list maker list interface (e.g., the ListMakerList interface 518, represented by a Iml parameter) may be used where the recording application receives this interface when the list making application is launched or repeated (e.g., ListMakerApp.Launch and ListMakerApp.Repeat methods). The list maker list interface may expose properties such as a count property to indicate the number of entries; a deep count property to indicate the number of entries, including child items; an items property to expose an enumerator that the CD/DVD recording application can use to access the collection of list items; and a list title property to retrieves a string containing the title of the list. Thus, in such a manner access is provided to a collection of user selected files where each item in the file collection may be an object that exposes an exemplary list maker item interface (e.g., the ListMakerItem interface 516, as called upon ListMakerApp.ItemAdded or ListMakerApp.ItemRemoved methods).

The exemplary application may also include a method or interface to retrieve information about the CD/DVD recording application, the recording hardware, the recording medium, etc. (e.g., the IBrandInfo interface 512). In particular, such methods or interfaces may retrieve the total capacity of the medium, and the amount of unused space remaining on the medium. Such information may be communicated to the user prior to, during or after a file selection and list making process.

Thus, as explained with respect to CD/DVD recording, This exemplary method is used to provide list items to the CD/DVD recording application and optionally to retrieve information from the recording application about the recording medium, etc., which may be communicated to the user prior to, during or after the file selection and list making process.

With respect to the aforementioned methods in relationship to CD/DVD recording, the Cancel method informs a CD/DVD recording application that the user canceled the list-making operation; the ItemAdded method informs a CD/DVD recording application that the user added a new file to the list; the ItemRemoved method informs a CD/DVD recording application that the user removed a file from the list; the Launch method starts a CD/DVD recording application; the RemoveAllItems method informs an application that the user clicked, for example, a Remove All button to remove all previously selected items from the list; and the Repeat method causes the CD/DVD recording application in to repeat the previous recording operation.

As mentioned, the exemplary application 600 may rely on capabilities of another application or hardware and a method or interface may exist to retrieve information pertaining to the application or hardware. For example, a brand information interface may be used to establish the identity of a CD/DVD recording application. In turn, such information may be used to customize list making capabilities, including the user interface(s) displayed.

An exemplary brand information interface (e.g., the IBrandInfo interface 512) exposes various properties such as a CreatePageTitle property that contains a string used as the title of a list creation page; a MainIcon property that specifies a path to a file containing an icon to use as a main icon (or watermark) on, for example, a CD/DVD creation page; a PageTitle property that contains a string used in a user interface, for example, placed in the upper-right corner of CD/DVD creation pages; a SaveListButtonTitle property that contains a string used in a user interface, for example, placed on a button that is used to finish a CD or DVD recording operation; a StatusBarIcon property that specifies a path to a file containing an icon used in a user interface, for example, placed in the lower-left corner of CD or DVD creation pages; a ViewListButtonTitle property that contains a string that for a user interface, for example, placed on a button that is used to view the media items to be copied to a CD or DVD; a ViewListIcon property that specifies a path to an icon file for a user interface, for example, placed at the top of a view-list page; and a ViewListPageTitle property that contains a string for a user interface, for example, as used as the title of a view-list page.

While the exemplary application 600 may include or rely on such a brand information interface and related properties, the aforementioned exemplary methods can expose various properties such as, but not limited to, the exemplary properties 603, which include: a BrandInfo property to provide an instance of the recording application's IBrandInfo object (see, e.g., the IBrandInfo interface 510); a ByteCapacity property to indicate the capacity of the CD or DVD (e.g., in bytes); a ByteUsed property to indicates the amount of CD or DVD space that has been used thus far; a CanProceed property that indicates whether the CD/DVD recording application can proceed with a recording operation; an ItemCapacity property that indicates the capacity of a CD or DVD, in items; an ItemUsed property that indicates the amount of CD or DVD space, in items, that has been used thus far; an OrderIsImportant property that indicates whether the user should be allowed to control the order of the files in the list; a PreferredStatusFormat property that indicates the format in which the CD/DVD recording application provides status information; a ProgressPercentage property that indicates the progress that the CD/DVD recording application has made in the recording operation; a ProgressType property that indicates whether the CD/DVD recording application reports its progress as the percentage completed, or as the amount of time remaining until completion; a Repeatable property that indicates whether to let the user repeat the previous CD or DVD recording operation; a StatusAsPercentage property that indicates whether the status is expressed as a percentage; a StatusIsRemaining property that indicates whether the status message should reflect the capacity of, or space remaining on, the CD or DVD; a SupportedMediaTypes property that indicates the types of media that the CD/DVD recording application supports; a TimeCapacity property that indicates the capacity of the CD or DVD, in recording time; a TimeRemaining property that indicates the estimated time remaining before the recording operation is completed; and a TimeUsed property that indicates the amount of recording time that has been used on CD or DVD.

As mentioned, the exemplary application 600 may be an add-in to an operating system and include delegates to handle completion of events from CD/DVD recording application(s), to contain information about the progress of a CD/DVD recording operation, to handle progress updates from CD/DVD recording application(s). For example, a ProgressChangedEventHandler delegate (e.g., a pce parameter) can be used to send progress updates and a CompletionEventHandler delegate (e.g., a ce parameter) can be used to notify when the recording operation has been completed.

The exemplary application 600 may include exceptions raised because the CD/DVD recording application does not support appending files to the current medium, the amount of available disc space is not adequate to complete the recording operation, an error occurred during a recording operation in which a fit-to-disc feature is being used, the recording device contains no recording medium, the recording application does not support the specified type of recording medium. Of course, other exceptions may exist such as, but not limited to, exceptions raised because an attempt was made to copy broadcast media content protected by Copy General Management System Analog (CGMS-A), another process is using the required recording device or other required device, an attempt was made to copy DRM-protected content, but the user has not been granted the right to copy the content, the file list contains a duplicate file, a file contains corrupted data, a file could not be located, problems with the installation of the recording or other required application, an exception was raised by a CD/DVD recording application while processing files, no recording device exists, the hard disk does not have enough space available to store temporary files, an exception was raised by a CD recording application indicating that a file is corrupted or is in an unsupported file format, and the user ended a recording operation before it was finished.

While this example refers generally to CD or DVD recording, any particular medium or media may be used to record. Further, a media type may be specified or enumerated with constants such as, but not limited to, Folder Media (folders), Music (recorded music), None (none), Pictures (pictures and images), RecordedTV (recorded TV shows), and Videos (video recordings). Other types may define how to interpret the progress reported by a CD/DVD recording application, define the format in which the CD/DVD recording application provides status information, etc.

The exemplary application 600 includes a set of features that are suitable for use with CD or DVD recording. An exemplary application and methods may be used to make a list for printing, recording, saving or other operations.

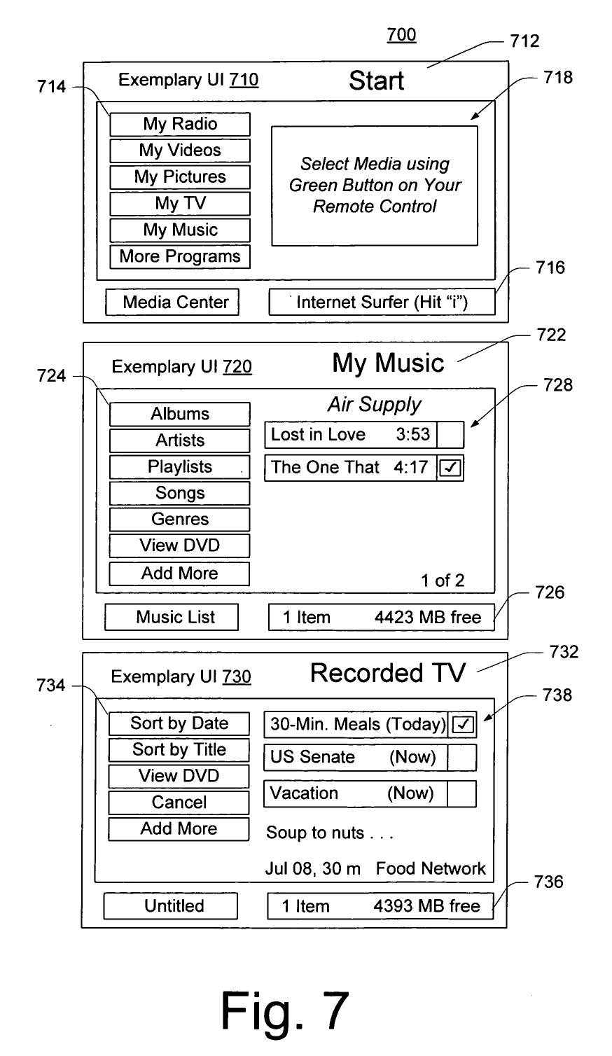

FIG. 7 shows various exemplary user interfaces 700 that may be used in a list making process. An exemplary start user interface 710, as indicated in by “Start” 712, allows a user to select various media from a menu 714. Other features include an Internet surfer 716 and an information area 718 that may help guide a user.

An exemplary user interface 720 corresponds to the “My Music” button on the user interface 710. A title box 722 indicates “My Music” to help guide the user. In this example, a menu 724 allows for various manners of categorizing music. A display area 728 displays a title of a band, artist, etc., and music items related to that title. For example, the band “Air Supply” is given and two songs displayed along with information as to duration of each song. Other information may relate to DRM, price, etc. Music is optionally listed from a Web site where it is available for download or playing. In such an example, the list making application receives information via a network (e.g., the Internet). It may also provide information for accounts that provide for payment, billing, etc. An information area 726 displays information related to the number of music items selected and the amount of space free on a medium for use in storing the music items of a item list, which may contain media other than music. The storage medium may be a CD, a DVD, a hard drive, RAM, a portable music device, etc. The music items selected may be stored in any of a variety of appropriate formats (e.g., mp3, wav, MIDI, etc.).

An exemplary user interface 730 displays a title “Recorded TV” 732. This user interface includes a menu 734, a display area 738 for displaying information about TV shows and checkboxes for selecting item for a list. An information area 736 displays the number of items selected and amount of storage space available on a storage medium.

Exemplary Computing Environment

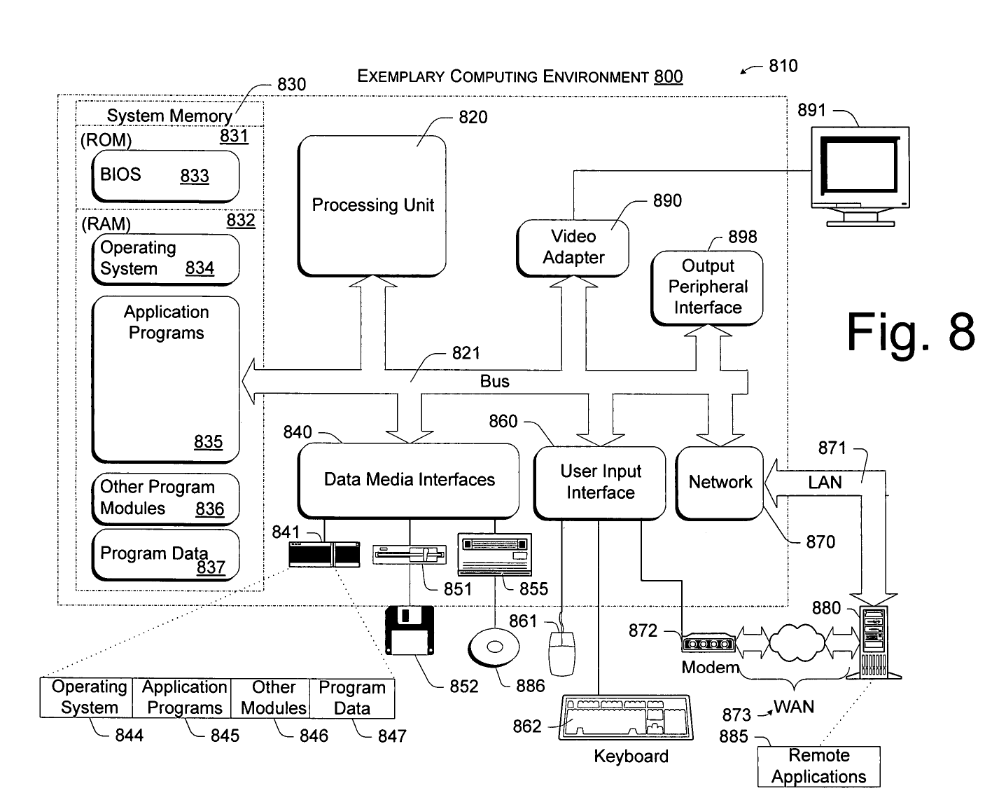

The various examples may be implemented in different computer environments. The computer environment shown in FIG. 8 is only one example of a computer environment and is not intended to suggest any limitation as to the scope of use or functionality of the computer and network architectures suitable for use. Neither should the computer environment be interpreted as having any dependency or requirement relating to any one or combination of components illustrated in the example computer environment.

FIG. 8 illustrates an example of a suitable computing system environment 800 on which various exemplary methods may be implemented. Various exemplary devices or systems may include any of the features of the exemplary environment 800. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

Various exemplary methods are operational with numerous other general purpose or special purpose computing system environments or configurations. Examples of well known computing systems, environments, and/or configurations that may be suitable for implementation or use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. For example, the exemplary context 100 of FIG. 1 may use a remote computer to generate information for display of a UI wherein the displayed UI operates in conjunction with a remote control or other input device.

Various exemplary methods, applications, etc., may be described in the general context of computer-executable instructions, such as program modules, being executed by a computer. Generally, program modules include routines, programs, objects, components, data structures, etc., that perform particular tasks or implement particular abstract data types. Various exemplary methods may also be practiced in distributed computing environments where tasks are performed by remote processing devices that are linked through a communications network or other communication (e.g., infrared, etc.). In a distributed computing environment, program modules may be located in both local and remote computer storage media including memory storage devices.

With reference to FIG. 8, an exemplary system for implementing the various exemplary methods includes a general purpose computing device in the form of a computer 810. Components of computer 810 may include, but are not limited to, a processing unit 820, a system memory 830, and a system bus 821 that couples various system components including the system memory 830 to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 5 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media (e.g., DVD, etc.). Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a data media interface such as interface 840, and magnetic disk drive 851 and optical disk drive 855 are typically connected to the system bus 821 a data media interface that is optionally a removable memory interface. For purposes of explanation of the particular example, the magnetic disk drive 851 and the optical disk drive use the data media interface 840.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus 821, but may be connected by other interface and bus structures, such as a parallel port, game port or a universal serial bus (USB). A monitor 891 or other type of display device is also connected to the system bus 821 via an interface, such as a video interface 890. In addition to the monitor 891, computers may also include other peripheral output devices such as speakers and printer, which may be connected through a output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the features described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in a remote memory storage device. By way of example, and not limitation, FIG. 8 illustrates remote application programs 885 as residing on the remote computer 880 (e.g., in memory of the remote computer 880). It will be appreciated that the network connections shown are exemplary and other means of establishing a communications link between the computers may be used.

Although various exemplary methods, devices, systems, etc., have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. A computer-implemented method comprising:
displaying a graphical user interface that comprises a menu of types of media;
receiving a command issued from a remote control specifying a type of media;
in response to the command, displaying a graphical user interface for selecting items of the type of media;
receiving one or more commands issued from the remote control to select items to thereby make a list of the items;
identifying an application associated with the type of media; and
providing information for the application wherein the information comprises one or more properties about each item of the list.

2. The computer-implemented method of claim 1 wherein the application provides for copying files associated with each item of the list to a storage medium.

3. The computer-implemented method of claim 1 wherein the types of media comprise at least video media, audio media and audio-visual media.

4. The computer-implemented method of claim 1 wherein the information comprises at least file size and file name.

5. The computer-implemented method of claim 1 wherein each item of the list has an associated file and wherein a graphical user interface displays the size of each file or a cumulative size for all files of the items on the list.

6. The computer-implemented method of claim 1 further comprising receiving one or more commands issued by a remote control to edit the list.

7. A computer-readable medium having computer-executable instructions for performing the method recited in claim 1.

8. A computer-readable medium having computer-executable modules comprising:
an information interface that provides information related to a list utilizing application;
a list maker interface that provides for making of a list of items;
a list maker list interface that provides a list utilizing application access to a collection of list items; and
a list maker item interface that provides the list utilizing application access to individual items of a list.

9. The computer-readable medium of claim 8 wherein the list maker list interface exposes properties related to the list.

10. The computer-readable medium of claim 8 wherein the list maker item interface exposes properties for each item of the list.

11. The computer-readable medium of claim 8 wherein the information interface exposes properties of the list utilizing application.

12. The computer-readable medium of claim 8 wherein the modules respond to commands issued by a remote control.

13. The computer-readable medium of claim 8 wherein the modules allow for making a list of song files and storing the song files to a storage medium.

14. The computer-readable medium of claim 13 wherein the storage medium comprises a portable music player.

15. The computer-readable medium of claim 8 wherein the modules allow for making a list of media files wherein the media files are accessed via a network.

16. A computer-readable medium having computer-executable modules comprising:
a cancel module for informing an application that a list-making procedure is cancelled;
an add module for informing the application that an item is added to a list; and
a removed module for informing the application that an item is removed from a list.

17. The computer-readable medium of claim 16 further comprising a computer-executable launch module for launching the application.

18. The computer-readable medium of claim 16 further comprising a computer-executable remove all items module for informing the application that all items are removed from a list.

19. The computer-readable medium of claim 16 further comprising a computer-executable repeat module for causing the application to repeat a prior action.

20. The computer-readable medium of claim 16 wherein the application provides for recording media files.
